(19) United States
(12) Patent Application Publication
(10) Pub. No.: US 2025/0334735 A1
(43) Pub. Date: Oct. 30, 2025

(54) CO-DESIGN OF CASCADED PASSIVE AND ACTIVE LAYERS FOR OPTICAL INTEGRATED CIRCUITS

(71) Applicant: Huawei Technologies Co., Ltd., Shenzhen (CN)

(72) Inventors: Mahdi Safari, Toronto (CA); Armaghan Eshaghi, Aurora (CA)

(21) Appl. No.: 18/645,126

(22) Filed: Apr. 24, 2024

(51) Int. Cl. G02B 6/12; G02B 6/13

(52) U.S. Cl. CPC G02B 6/12004; G02B 6/13

(57) ABSTRACT

An optical integrated circuit is described that is constructed from a plurality of passive layers and active layers, arranged in a cascaded order, alternating between passive layer and active layer. Each passive layer relates its inputs to its outputs through a respective transmission matrix that may be implemented as an inverse designed diffractive block, such as metasurface. Each active layer includes one or more reconfigurable optical phase shifters. The layouts of each of the plurality of passive layers and the plurality of active layers are jointly determined using co-design having an optimization function incorporating parameters for the passive layers and the active layers.

### FIELD

The present application relates to optical integrated circuits and, in particular, optical switching or computation using integrated optical elements.

### BACKGROUND

Integrated photonics are of current interest in computing since they seem to promise potential energy efficiency and may enable high computing rates. However, the design and implementation of practical optical integrated circuits that are low power, low noise, and that have a reasonably small footprint, remains a challenge.

### BRIEF DESCRIPTION OF THE DRAWINGS

Reference will now be made, by way of example, to the accompanying drawings in which:

FIG. 1 diagrammatically illustrates an example optical integrated circuit;

FIG. 2 shows an example of an optical integrated circuit to implement a 4×4 switch;

FIG. 3 shows an example of an optical integrated circuit to implement a 3×3 switch; and

FIG. 4 shows, in flowchart form, one example process for determining an optical integrated circuit.

Like reference numerals are used in the drawings to denote like elements and features.

### DETAILED DESCRIPTION

In one aspect, the present application describes an optical integrated circuit. The circuit may include a plurality of passive layers, each passive layer having input ports and output ports and being configured to relate its input ports to its output ports through a transmission matrix; and a plurality of active layers, each active layer including one or more reconfigurable optical phase shifters. The passive layers and active layers may be arranged in a cascaded order alternating between passive layer and active layer, and layouts of each of the plurality of passive layers and the plurality of active layers may be jointly determined using inverse co-design having an optimization function incorporating parameters for the passive layers and the active layers.

In some implementations, each passive layer is a respective inverse designed diffractive block formed of diffraction elements. In some cases, a solution to the optimization function specifies a respective pattern of the diffraction elements for each of the respective inverse designed diffractive blocks.

In some implementations, each passive layer is a Mach-Zehnder Interferometer (MZI) mesh, and the MZI mesh includes phase shifters, and the phase shifters are fixed to implement the transmission matrix.

In some implementations, the optical integrated circuit includes N inputs and M outputs, and wherein each active layer includes fewer than N phase shifters. In some cases, a solution to the optimization function specifies, for each of the active layers, a number of phase shifters for that active layer and a position of the phase shifters within that active layer. In some cases, M is equal to N and the optical integrated circuit is an N×N switch. In some examples, the plurality of active layers includes N−1 active layers and the plurality of passive layers includes N passive layers.

In some implementations, the optimization function includes respective matrices corresponding to each of the active layers and passive layers, wherein each matrix corresponding to one of the passive layers contains parameters specifying that passive layer, and wherein each matrix corresponding to one of the active layers contains parameters specifying phase shifters in that active layer. In some cases, the optimization function includes a multiplication of the respective matrices in the cascaded order and a product of the multiplication is a set of permutations of outputs of the optical integrated circuit.

In some examples, a solution of the optimization function produces optimized matrices that contain the parameters. In some examples, the optimized matrices include optimized active layer matrices that each specify, for a respective active layer, a number of phase shifters for that active layer and a position of the phase shifters within that active layer. In some cases, the optimized active layer matrices include a set of diagonal elements each representing potential phase shift between respective input and output lines to the optimized active layer, and the diagonal elements each specify an angular parameter that indicates whether that respective input and output line include one of the phase shifters and the phase shift to be applied.

In some cases, the optimized matrices may include optimized passive layer matrices that each specify, for a respective passive layer, a layout of elements to realize the transmission matrix relating the input ports to the output ports of that respective passive layer. In some examples, the optimized passive layer matrices are each used in an inverse design process to determine the layout of elements specifying an inverse designed diffractive block implementing respective ones of the passive layers.

In some implementations, the cascaded order interleaves the plurality of passive layers with the plurality of active layers resulting in a series of layers alternating between the passive layers and the active layers. In some embodiments, each active layer is between two of the passive layers.

In some implementations, the optical integrated circuit includes N inputs and N outputs, and wherein each passive layer and each active layer includes N inputs and N outputs.

In another aspect, the present application describes an optical integrated circuit that includes a plurality of passive layers; and a plurality of active layers, each active layer including one or more reconfigurable optical phase shifters. The passive layers and active layers are arranged in a cascaded order alternating between passive layer and active layer, and layouts of each of the plurality of passive layers and the plurality of active layers are jointly determined using inverse co-design having an optimization function incorporating parameters for the passive layers and the active layers. Each of the passive layers is a respective inverse designed diffractive block formed of diffraction elements determined using an inverse design process to realize the parameters determined by the optimization function. Each active layer contains the one or more reconfigurable optical phase shifters within that active layer in positions and providing phase shifts determined by the optimization function.

In yet a further aspect, the present application describes a method of fabricating an optical integrated circuit. The method may include selecting a number of input ports, a number of output ports, a number of passive layers, and a number of active layers; solving an optimization function constructed as a matrix multiplication arranged in an interleaved order of alternating matrices corresponding to passive and active layers, wherein the optimization function is equal to a set of permutations of output states of the optical integrated circuit, and wherein a solution provides elements of the respective matrices; for each of the passive layers, determining a layout of elements of that layer based on the elements of its respective matrix determined by the optimization function; for each of the active layers, determining a number of optical phase shifters and their respective positions within the active layer based on the elements of its respective matrix determined by the optimization function; and fabricating the optical integrated circuit based on the layout of elements for each of the passive layers and the respective positions of the optical phase shifters for each of the active layers.

Other aspects and features of the present application will be understood by those of ordinary skill in the art from a review of the following description of examples in conjunction with the accompanying figures.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

In the interest of pursuing increased speed, computational power, power savings, optical technology has become of increased interest. In particular, optical switching and computation are of interest partly due to the high bandwidth and low power consumption of optical elements.

In the past, optical switching and computing have typically been implemented using crossbar ring structures and Mach-Zehnder Interferometer (MZI) lattices. However, these devices suffer from high cross talk, high insertion loss, and high number of active elements, which limits the scalability of these devices.

In more recent developments, inverse design has been used to realize passive diffractive structures, sometimes called metasurfaces, that are able to relate a set of input ports to a set of output ports. These inversely designed structures use a diffractive block made out of pixelated elements to achieve an arbitrary S-parameter from multiport blocks. The approach is based on optimizing the diffractive block to achieve the desired S-parameter by pixelating the diffractive unit with 2 state pixels, wherein silicon is etched and not etched. Recently there have been studies on the idea of incorporating one or more reconfigurable pixels within an inversely designed structure to achieve dynamic diffractive block and optical switching. These reconfigurable inverse design elements are in simulation phase. At present, these devices have very low number of ports due to the intensity of the computation required for the design, so they tend to be simplistic. For example, there has been one study proposing an on-off switch using inverse pixelated design. There has also been an attempt to design a 1×3 optical switch using inclusions with variable permittivity values. Finally, there has been a paper on use of reconfigurable phase change material (PCM) for the entire diffractive block with two states to switch between two ports. All, the proposed studies are not scalable and are limited to few number of ports due to limited degrees of freedom of the active elements.

Another disadvantage to the concept of incorporating a reconfigurable element, like a PCM pixel, within an inverse designed diffractive block, is scalability and fabrication problems. Achieving a small active pixel within a pixelated design is very challenging. In addition, the design of these types of elements with a higher number of ports requires heavy computation and may introduce high loss and cross talk. Therefore, scaling these devices to higher number of ports is very challenging and the proposed solutions are at the simulation level and small port counts.

In accordance with one aspect of the present application, co-design (e.g. joint optimization) may be used to determine an optical integrated circuit made up of a cascaded series of active and passive layers or stages. In many examples, the cascaded series alternates between active and passive layers. The optical integrated circuit may have N input ports and M output ports. In some cases, the circuit may be configured to implement an N×M switch. In some cases, the switch is an N×N switch. In some cases, the circuit may be configured to implement more complex routing and/or signal operations so as to realize a dynamic multi-state transmission matrix relating input ports to output ports. In some cases, the circuit may be configured to perform one or more optical processing functions or operations as an optical processor.

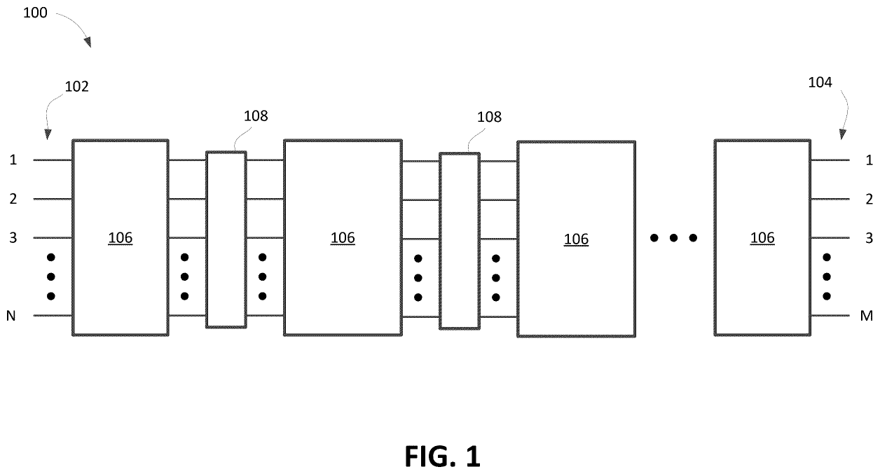

Reference is first made to FIG. 1, which diagrammatically illustrates an example optical integrated circuit 100. The optical integrated circuit 100 includes N input ports 102 and M output ports 104. M may equal N in some cases.

The circuit 100 includes a set of passive layers 106 or stages interleaved with active layers 108 to form a cascaded series of active and passive layers. That is, the layers are arranged in a cascaded order, alternating between passive layers 106 and active layers 108. Each passive layer 106 relates the input ports to that passive layer 106 to its output ports through a transmission matrix. Implementation of the passive layers 106 may be through diffractive elements, such as in a metasurface that may be formed using inverse diffractive design. In some cases, implementation of the passive layers 106 may be through tunable passive units, such as meshes, as will be described further below.

The active layer 108 includes a set of one or more phase shifters between its inputs and outputs. The active layer 108 may have up to N phase shifters in some cases. Active layers 108 may have fewer than N phase shifters. That is, in some cases an input may be directly connected to an output through the active layer 108 without any phase shift or other manipulation. The active layers 108 may employ phase change material (PCM) based phase shifters. The active layers 108 may be reconfigurable optical network layers.

Through the use of co-design (e.g. joint optimization) of the active and passive layers, the optical integrated circuit 100 may be designed to implement a particular optical manipulations or operation. The co-design may be carried out to realize a set of permutations that reflect the different possible states of the circuit 100. The passive layers 106 may be arbitrarily complex matrices, which are passive and reciprocal. An optimization function may used to derive the complex matrix elements and the phase shifts at active layers to achieve the corresponding set of permutations. In some cases, once the matrices are derived another optimization may be used to realize the passive blocks with inversely designed diffractive architecture. In some cases, the inverse design of the diffractive architecture for the passive layers 106 may be carried out within the joint optimization rather than separately in a second optimization step.

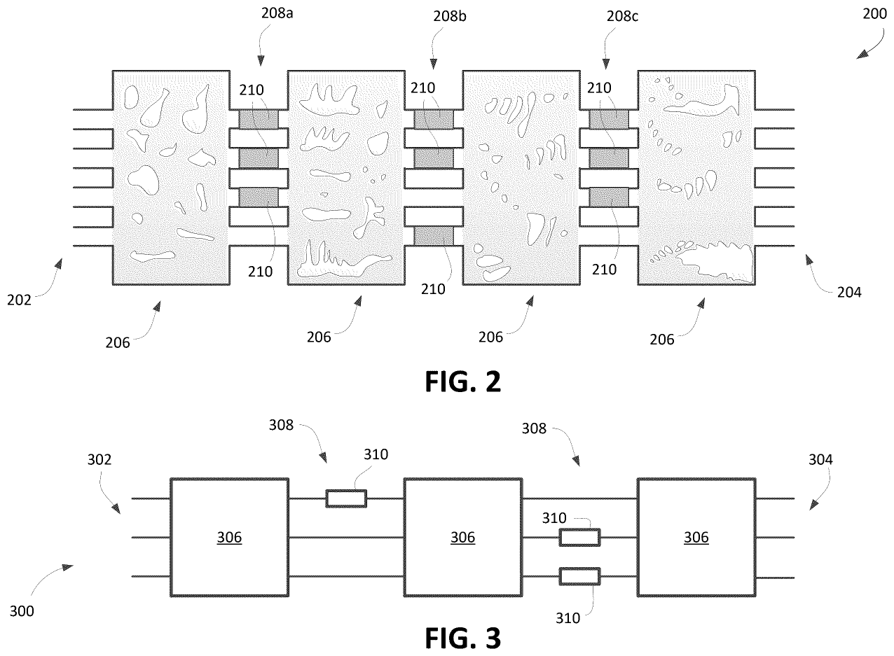

FIG. 2 shows an example of an optical integrated circuit 200 to implement a 4×4 switch. The circuit 200 includes four input ports 202 and four output ports 204. The cascaded series of layers that make up the circuit 200 include four passive layers 206 and three active layers 208 (labelled individually as 208a, 208b, and 208c). The passive layers 206 in this example are inverse designed diffractive blocks that each relate the four inputs into that diffractive block to its four outputs.

It will be noted that the three active layers 208 each include one or more phase shifters, but not necessarily a phase shifter between each input and output to the active layer 208. In this example, the first active layer 208a includes three phase shifters 210, but the fourth input and output to that layer are directly connected without any phase shift being applied. The second active layer 208b includes three phase shifters 210, but the third input and output to that layer are directly connected without any phase shift being applied.

The solution to the co-design optimization indicates which inputs and outputs to one of the active layers 208 is to include a phase shift and the nature of the phase shift.

Co-design optimization may partly be realized by determining a set of cascaded matrices. Each matrix represents either a passive layer or an active layer. During the co-design optimization, the number of layers may be selected such that there are sufficient degrees of freedom to realize the number of permutations that the optical integrated circuit is intended to provide.

Consider, for the purposes of illustration, the case of a 3×3 switch. The co-design of such an optical integrated circuit may begin with selection of the number of passive and active layers to be included in the cascaded series of layers that make up the optical integrated circuit. Assuming that the circuit is to include three passive layers and two active layers, the co-design process may define five matrices, M_{A}, M_{B}, M_{C}, M_{D}, M_{E}, each representing one of the five layers. The number of permutations of the 3×3 optical switch are 3!=6 different states. The set of states is shown in the expression below:

$${M}_{A} \times {M}_{B} \times {M}_{C} \times {M}_{D} \times {M}_{E} = \{ \begin{matrix}[ 010 , 001 , 100 ] & state 1 \\ [ 010 , 100 , 001 ] & state 2 \\ [ 100 , 001 , 010 ] & state 3 \\ [ 100 , 010 , 001 ] & state 4 \\ [ 001 , 100 , 010 ] & state 5 \\ [ 00 \; 1 , 101 , 100 ] & state 6\end{matrix}$$

In the above expression, the matrices M_{B}, M_{D} may represent the two active layers interleaved with the three passive layers, M_{A}, M_{C}, M_{E}. The three active layers are arbitrarily complex transmission matrices. The two active layers may be expressed in matrix form as:

$${M}_{B} , {M}_{D} = [ \begin{matrix}exp ( j {φ}_{1} ) & 0 & 0 \\ 0 & exp ( j {φ}_{2} ) & 0 \\ 0 & 0 & exp ( j {φ}_{3} )\end{matrix} ]$$

In the above expression, angular parameters φ₁, φ₂, φ₃, represent the potential phase shifts at those respective lines, e.g. connecting an input to an output. If the optimization determines that no phase shift is to be applied at that line, then the angular parameter is zero at that line.

Any suitable optimization process may be used to find the values of the matrices. The optimization process results in a set of active matrices, e.g., M_{B}, M_{D}, that specify the phase shift to be applied, if any, within the values contained on the diagonal. From these values, the angular parameters φ₁, φ₂, φ₃, may be obtained, which are then used to determine implementation of each of the active layers and which lines of each layer have phase shifters and the phase shifts that the phase shifters are to apply. The other elements of the active matrices may be set to zero.

The optimization process also results in a set of passive matrices M_{A}, M_{C}, M_{E} of arbitrary complex elements. Each of these matrices is transmission matrix relating inputs to outputs. Inverse design may then be used to realize each passive layer by a diffractive architecture, such as a metasurface. The inverse design may employ an optimization expression and may be solved iteratively to a point of convergence. The point of convergence may be selected based on balance of accuracy and computing time or power. In some cases, the optimization is an error minimization expression and the acceptable minimized error is used to set the point of convergence. In some cases, the inverse design of the passive layers is incorporated into the overall optimization process for determining the values of the matrices.

FIG. 3 diagrammatically shows one example of an optical integrated circuit 300 implementing a 3×3 switch arrived at through the above-described co-design process. In this example, the circuit includes three input ports 302 and three output ports 304. The cascaded series of layers that make up the circuit 300 include three passive layers 306 and two active layers 308 (labelled individually as 308a and 308b).

The two active layers 308 include one or more phase shifters. In this example, the first active layer 308a includes one phase shifter 310, but the second and third input and output to that layer are directly connected without any phase shift being applied. The second active layer 308b includes two phase shifters 310, but the first input and output to that layer are directly connected without any phase shift being applied.

Accordingly, in this example the first active layer 308a only includes one phase shifter and the second active layer 308b includes two phase shifters, which means that angular parameters φ₂, φ₃=0 for M_{B} and φ₁=0 for M_{D}. This means 3×3 optical switching can be achieved with only three phase shifters, which allows for scalability.

Also, it will be noted that the proposed structure is not limited to the provided examples. The arrangement of phase shifters can change within the design and the number of layers can be increased to address a higher number of ports and to scale up the circuit to more complex configurations. It will also be appreciated that the above-described co-design process for a cascaded series of active and passive layers results in active layers that do not necessarily include a phase shifter for each input and output port, which allows for significant scalability. One formation for this architecture may be to realize an N by N switching unit using N passive layers and N−1 active layers wherein the active layers include from 1 up to (N−1) active elements (e.g. phase shifters). In some implementations, the phase shifters in the active layer are made of phase change materials (PCM) to use non-volatile functionality so that the design is more power efficient.

It may also be appreciated that the passive layers in the above-described embodiments are inversely designed diffractive blocks that are within μm scale and replicate the matrix of the passive block derived from the co-design of active and passive layers to achieve the optical switching permutations. Therefore, in this approach the combination of the derived passive block and active layer states (which provide the phase value of phase shifters) results in the optical switching permutations at each state.

In some other embodiments, instead of implementing the passive layers using inverse design to realize them using diffractive elements (e.g. metasurfaces), the passive layers may be implemented using tunable passive elements, such as an MZI mesh or a multimode interferometer (MMI) unit. In one example, the transmission matrix for a passive layer may be implemented using a MZI mesh. Note, however, that although an MZI mesh network contains active components, the phase shifters of the MZI mesh are to be fixed during operation; therefore, they would not draw any power and they can still can be referred to as a passive layer or stage. The use of a tunable MZI mesh network to implement the passive layer may also help with fine tuning of the passive structure in the case of fabrication errors or inaccuracies.

A sensitivity study has been carried out on the 3×3 optical switching using MZI structures as the passive layers. The sensitivity of the design was tested through varying one of the phase shifters in the active layer around the center (optimized) value by +10% of its value, which resulted in a 30 dB extinction ratio in the worst-case scenario. This demonstrates that the optical integrated circuit device performs within the standard of optical switching and can offer a smaller footprint and a lower number of active layers and active elements as comparted to other optical 3×3 switches and results in lower power consumption.

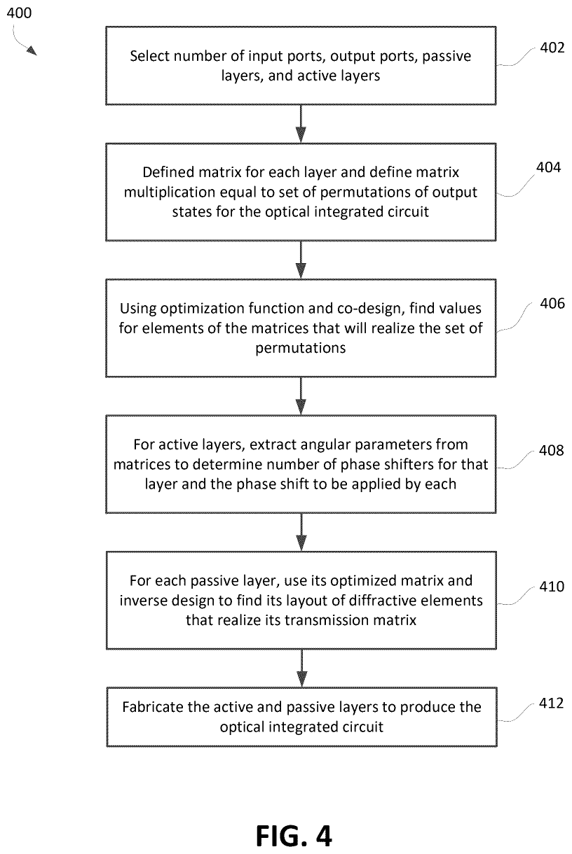

Reference is now made to FIG. 4, which shows, in flowchart form, one example process 400 for determining an optical integrated circuit. The process 400 includes, in operation 402, first setting a number of input ports and output ports and selecting a number of passive layers and active layers for the optical integrated circuit. In the case of a switch, the number of ports may be N×N, for example. In some cases, with an N×N device, the number of layers or stages may be selected as N passive layers and N−1 active layers.

In operation 404, matrices are defined for each layer. The matrices will describe the transmission matrix relating inputs to outputs. The matrices may have a size corresponding to the number of inputs and outputs for that layer. For example, if the circuit is of size N×N, then each layer may be configured to have N inputs and N outputs and the matrices may each be N×N. The matrices are multiplied together in an order matching the order of the corresponding layers in the concatenated series of layers. In the circuit, the active and passive layers are interleaved in the concatenated series, meaning that the matrices corresponding to the respective active and passive layers are interleaved in the matrix multiplication expression. The matrix multiplication is defined as equal to a set of permutations of output states. That is, the matrices, when multiplied in order, are to enable or realize the full set of permutations in terms of output states. The matrices corresponding to the passive layers have a set of arbitrary and as-yet unknown elements. The matrices corresponding to the active layers have a set of elements corresponding to a possible phase shift per input and output pair.

In one example, where the circuit is has N×N ports it may have N! states for each reconfigurable component and it may have up to about N reconfigurable components per active layer. The number permutations in the set of permutations may be up to N! states.

In operation 406, an optimization function or procedure is utilized together with inverse co-design to find values of the elements of the matrices. That is, using the matrix multiplication expression and an optimization process, the expression is solved to find the elements of the matrices that will realize, within some level of tolerance, the set of permutations of output states. For example, the optimization process may be carried out using a merit function minimizing a least mean square error across all elements of the output matrix. This may be aligned with targeted optical permutations across the set of switching states. To illustrate with a specific example, in the case of a 3×3 switch with three phase shifters, the optimization may encompass a total of 6×9 parameters. The minimization of this merit function may be pursued through an implementation of the Broyden-Fletcher-Goldfarb-Shanno (BFGS) algorithm in some cases. Such an algorithm give optimized parameters for the passive layers in the form of 3×9 complex values, and phase shifter states which in this example means 3×6 real phase shift values.

Once the elements of the matrices have been found, in operation 408, for each active layer the non-zero elements indicate the phase shift, if any, to be applied by one of the phase shifters. Elements set to 1 may indicate no phase shift and no phase shifter required for a particular input-output pairing in that state. The non-zero elements that indicate a phase shift also indicate the parameters of the phase shift. Accordingly, each matrix corresponding to an active layer indicates how many phase shifters are required and what phase shifts are to be applied in various states. In one implementation, the number and position of phase shifters may be specified in advance through set-up of the matrices. In another implementation, the optimization process may incorporate a minimization of number of phase shifters as an objective. In some embodiments, the optimization process may include testing convergence across a set of possible phase shifter counts and positions.

In operation 410, for each passive layer, the resultant matrix corresponding to that passive layer is used as the design goal an in inverse design process to find its pattern of diffractive elements, e.g. a metasurface. The passive layer may then, based on the inverse design results, be realized by a diffractive block of pixelated elements. As noted above, in some embodiments, the passive layer may be implemented by an MMI unit or an MZI mesh instead of by an inverse designed metasurface. As noted above, in some implementations operation 410 is effectively incorporated into operation 406 in that the design of the diffractive block pattern of pixelated elements is incorporated as parameters to the optimization, although this would make the optimization process of operation 406 more complex.

Having determined the implementation details of the passive and active layers, the optical integrated circuit is then fabricated based on those designs, as indicated by operation 412.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

What is claimed is:

1. An optical integrated circuit, comprising:
a plurality of passive layers, each passive layer having input ports and output ports and being configured to relate its input ports to its output ports through a transmission matrix; and
a plurality of active layers, each active layer including one or more reconfigurable optical phase shifters,
wherein the passive layers and active layers are arranged in a cascaded order alternating between passive layer and active layer,
and wherein layouts of each of the plurality of passive layers and the plurality of active layers are jointly determined using inverse co-design having an optimization function incorporating parameters for the passive layers and the active layers.

2. The optical integrated circuit of claim 1, wherein each passive layer is a respective inverse designed diffractive block formed of diffraction elements.

3. The optical integrated circuit of claim 2, wherein a solution to the optimization function specifies a respective pattern of the diffraction elements for each of the respective inverse designed diffractive blocks.

4. The optical integrated circuit of claim 1, wherein each passive layer is a Mach-Zehnder Interferometer (MZI) mesh, and the MZI mesh includes phase shifters, and wherein the phase shifters are fixed to implement the transmission matrix.

5. The optical integrated circuit of claim 1, wherein the optical integrated circuit includes N inputs and M outputs, and wherein each active layer includes fewer than N phase shifters.

6. The optical integrated circuit of claim 5, wherein a solution to the optimization function specifies, for each of the active layers, a number of phase shifters for that active layer and a position of the phase shifters within that active layer.

7. The optical integrated circuit of claim 5, wherein M is equal to N and wherein the optical integrated circuit is an N×N switch.

8. The optical integrated circuit of claim 7, wherein the plurality of active layers includes N−1 active layers, and wherein the plurality of passive layers includes N passive layers.

9. The optical integrated circuit of claim 1, wherein the optimization function includes respective matrices corresponding to each of the active layers and passive layers, wherein each matrix corresponding to one of the passive layers contains parameters specifying that passive layer, and wherein each matrix corresponding to one of the active layers contains parameters specifying phase shifters in that active layer.

10. The optical integrated circuit of claim 9, wherein the optimization function includes a multiplication of the respective matrices in the cascaded order, and wherein a product of the multiplication is a set of permutations of outputs of the optical integrated circuit.

11. The optical integrated circuit of claim 9, wherein a solution of the optimization function produces optimized matrices that contain the parameters.

12. The optical integrated circuit of claim 11, wherein the optimized matrices include optimized active layer matrices that each specify, for a respective active layer, a number of phase shifters for that active layer and a position of the phase shifters within that active layer.

13. The optical integrated circuit of claim 12, wherein the optimized active layer matrices include a set of diagonal elements each representing potential phase shift between respective input and output lines to the optimized active layer, and wherein the diagonal elements each specify an angular parameter that indicates whether that respective input and output line include one of the phase shifters and the phase shift to be applied.

14. The optical integrated circuit of claim 11, wherein the optimized matrices include optimized passive layer matrices that each specify, for a respective passive layer, a layout of elements to realize the transmission matrix relating the input ports to the output ports of that respective passive layer.

15. The optical integrated circuit of claim 14, wherein the optimized passive layer matrices are each used in an inverse design process to determine the layout of elements specifying an inverse designed diffractive block implementing respective ones of the passive layers.

16. The optical integrated circuit of claim 1, wherein the cascaded order interleaves the plurality of passive layers with the plurality of active layers resulting in a series of layers alternating between the passive layers and the active layers.

17. The optical integrated circuit of claim 16, wherein each active layer is between two of the passive layers.

18. The optical integrated circuit of claim 1, wherein the optical integrated circuit includes N inputs and N outputs, and wherein each passive layer and each active layer includes N inputs and N outputs.

19. An optical integrated circuit, comprising:
a plurality of passive layers; and
a plurality of active layers, each active layer including one or more reconfigurable optical phase shifters,
wherein the passive layers and active layers are arranged in a cascaded order alternating between passive layer and active layer,
wherein layouts of each of the plurality of passive layers and the plurality of active layers are jointly determined using inverse co-design having an optimization function incorporating parameters for the passive layers and the active layers,
wherein each of the passive layers is a respective inverse designed diffractive block formed of diffraction elements determined using an inverse design process to realize the parameters determined by the optimization function,
and wherein each active layer contains the one or more reconfigurable optical phase shifters within that active layer in positions and providing phase shifts determined by the optimization function.

20. A method of fabricating an optical integrated circuit, comprising:
selecting a number of input ports, a number of output ports, a number of passive layers, and a number of active layers;
solving an optimization function constructed as a matrix multiplication arranged in an interleaved order of alternating matrices corresponding to passive and active layers, wherein the optimization function is equal to a set of permutations of output states of the optical integrated circuit, and wherein a solution provides elements of the respective matrices;
for each of the passive layers, determining a layout of elements of that layer based on the elements of its respective matrix determined by the optimization function;
for each of the active layers, determining a number of optical phase shifters and their respective positions within the active layer based on the elements of its respective matrix determined by the optimization function; and
fabricating the optical integrated circuit based on the layout of elements for each of the passive layers and the respective positions of the optical phase shifters for each of the active layers.
